(19) United States
(12) Patent Application Publication
(10) Pub. No.: US 2014/0162227 A1
(43) Pub. Date: Jun. 12, 2014

(54) METHOD FOR PREVENTING THE DEVELOPMENT OF LUDOPATIA

(71) Applicants: Matteo Temporin, Torino (TO) (IT); Graziano Bugatti, Torino (TO) (IT)

(72) Inventors: Matteo Temporin, Torino (TO) (IT); Graziano Bugatti, Torino (TO) (IT)

(73) Assignee: GAMBLING & RESPONSIBILITY S.R.L., Trieste (IT)

(21) Appl. No.: 14/122,004

(22) PCT Filed: May 24, 2012
(86) PCT No.: PCT/IB2012/001014

§ 371 Date: Mar. 3, 2014

(30) Foreign Application Priority Data
May 26, 2011 (IT) MI2011A000956

(51) Int. Cl. G07F 17/32

(52) U.S. Cl. CPC G07F 17/3237
USPC 434/236

(57) ABSTRACT

A method is described for preventing the development of ludopatia in a person, or gambler, who interacts with an on-line or video lottery type game during one or more gaming sessions. The method comprises identifying the behaviour of a gambler and assigning to this behaviour a value indicating the predisposition of the person to develop ludopatia. If the value thus defined exceeds a certain threshold, determined according to a behaviour reference model, the necessary measures are adopted to induce the person to modify his/her behaviour.

### FIELD OF THE INVENTION

The present invention concerns a method for preventing the development of ludopatia in a gambler who interacts with an on-line or video lottery type game.

### PRIOR ART

The widespread diffusion of on-line and video lottery type games has highlighted in recent years an alarming tendency to the increasingly frequent development of ludopathy behaviour, i.e. behaviour typical of gambling addiction.

Also in the recent laws, the problem of ludopatia is considered a pathology comparable to alcohol, drug and smoking addiction.

Considerable research into this topic has been carried out in terms of number of studies, breadth and reliability of documentation, but medical-psychological treatment is not common and, when it does occur, it takes the form of a voluntary initiative on the part of the person concerned. In addition to the dramatic personal and social consequences on the gamblers affected, the social costs of the therapy to cure an addiction of this type are very high and the treatment times are very long (up to approximately 5 years).

A possible a priori provision consists, for example, in defining limits to the monetary value of the single bets and in guaranteeing a fair gaming mechanism. However, this type of approach can be easily and indefinitely overcome by the inveterate gambler.

Other possible a priori provisions consist for example in repositioning the gaming machines, so that they are located well away from places popular with children and young people, providing police supervision and control, and promoting awareness via information campaigns and similar. All these types of provisions, although desirable, take a long time and require investments in people and facilities which are generally not feasible for the local administrations; in any case they are provisions aimed at informing, with the limits inevitably typical of operations of this type.

These approaches do not intervene directly on the game or, more precisely, they do not “interfere” with the game. They act on the gambling addict in terms of treatment and medical-psychological dialogue and, possibly, community therapy; or they intervene on the machines (guaranteeing that they are not rigged) and on the rules (lowering the value of the bets), but the accustomed gambler is always able to adapt to this context; or they act on the surrounding environment, trying to “remove” the stimulus or the temptation which, however, can be easily found in the next street or directly on the Internet, i.e. from home.

Some attempts to propose solutions to this problem have been illustrated for example in the Australian patent application no. AU 2006222664, which proposes the printing of a warning message for the player at the end of the gaming session, as in the preceding Japanese patent application no. JP 10094666, which proposes warning the players when they exceed a maximum loss limit previously set by the players themselves.

The international patent application no. WO 2005/022453 proposes a system to facilitate the responsible behaviour of the gambler. The behaviour of the gambler is compared with a predefined model and, if a potential ludopathy behaviour is identified, a central system sends a message to the gambler in various possible modes, not only on the same terminal on which he/she is playing but also on any portable means of communication, for example mobile phones or similar, or via the Internet in the form of email messages.

However, the simple display of messages may be ineffective. Gamblers generally do not realise that they are developing ludopathy behaviour and could therefore consider the messages they receive as not relevant to them.

Furthermore, the managers and administrators who provide on-line and video lottery type games do not generally tolerate excessively invasive interventions during the game, for example temporary or permanent interruption of a gaming session.

### SUMMARY OF THE INVENTION

In view of the above, one object of the present invention is to propose a method for identifying and preventing degeneration of gaming behaviour in a gambler who interacts with an on-line or video lottery type game.

A further object of the present invention is to propose a method and a system that allows control of the machine or gaming program with which the gambler interacts, so as to avoid the game leading to degenerative behaviour in the gamblers interacting with the game.

Still another object of the present invention is to propose a method and a system that discourage and/or prevent the onset of ludopatia when symptoms that can be related to the potential development of ludopatia are encountered in a gambler.

A further object of the present invention is to propose a method and a system that allow the collection and analysis of data to permit an evaluation of the diffusion and gravity of gambling addiction.

In accordance with a first aspect of the present invention, these objects are achieved thanks to a method according to claim 1 for preventing the development of ludopatia in a person, or gambler, who interacts with an on-line or video lottery type game in the course of one or more gaming sessions. Further characteristics and advantages are given in the dependent claims.

The method according to the invention takes account of the fact that the characteristics of a game of this type are defined at least by the parameters “payback” and “probabilistic distribution of the prizes”. In particular the method comprises the steps of:

a) providing a behavioural reference model constructed on the basis of statistics relative at least to the sums bet, the sums lost and the sums won within the context of a significant sample of gamblers, in which the behavioural reference model provides a scale of values corresponding to the psychometric measurement of various degrees of ludopatia;

b) identifying the behaviour of the gambler during at least one gaming session and associating a value corresponding to the predisposition of the gambler to develop ludopatia on the basis of the gambler's behaviour;

c) displaying at least one warning message on an interface monitor between game and gambler if the value corresponding to the predisposition of the gambler to develop ludopatia exceeds a pre-set threshold in the range of the scale of values corresponding to the psychometric measurement of various degrees of ludopatia.

The method according to the present invention provides in particular for the modification of at least one of the parameters of payback and probabilistic distribution of the prizes to induce the gambler to modify his/her behaviour.

The term “payback” indicates the percentage of the bets that is redistributed in prizes. The expression “probabilistic distribution of the prizes” generally identifies a table that contains the probability of the occurrence of a certain set of random events and the amount of the prize at the occurrence of each event. Very different probabilistic distributions of the prizes are possible from game to game: for example, it is possible that the majority of the payback is won with very rare events that pay the stakes many times, or with very frequent events that pay the stake only a few times, or a complex mixture of the two extremes.

It has been found that the behaviour of the gamblers with respect to the modern gambling systems, for example video lottery, does not normally consist in laying single isolated bets over a period of time, but several bets in rapid succession, also using the result of the wins of the previous bets.

Taking account of this, it is therefore evident that the payback and probabilistic distribution of the prizes influence the duration of the game and the exposure of the gambler to the development of addictive behaviour. In the case of a very high payback (for example 95% of the bets) and a probabilistic table containing frequent low wins, the gambler may repeat his/her bets many times before finishing the available sum. This therefore extends the gaming time and the exposure of gamblers to possible moments of loss of control of their gaming activities.

In many scientific studies it has been highlighted that the onset of ludopatia is correlated with the frequency of the gaming activities. It has also been found that if the distribution of small but very frequent prizes is associated with some very high prizes, even if infrequent, gamblers are induced more frequently to follow up their losses, in the hope of making them good with a big win (chasing). This is one of the most frequent pathological situations in the pathological gambler, as in gamblers that are developing ludopathy behaviour.

It is therefore evident that both the level of payback and the probabilistic distribution of the prizes are significantly correlated with the risk of the onset of ludopatia.

The desired effect according to the present invention is not to cure a gambler (this normally takes five years of therapy), but to prevent the development of behaviour leading to ludopatia. As has been scientifically demonstrated by several studies and research works, the repetition of actions similar to those of a pathological gambler leads to ludopatia.

By modifying the parameters that characterise the game it is possible to effectively discourage the gambler from continuing with behaviour as highlighted above; for example, by modifying the parameters payback and/or probabilistic distribution of the prizes, the particularly insidious practice of following up losses can be reduced: the game loses its interest for the gamblers, who realise that they will not be able to make up their losses with a subsequent single big win, and this effectively helps to modify the potentially dangerous behaviour of the gambler.

This can occur during a single gaming session, for example if the gambler interacts anonymously with a video lottery type game, or before beginning an on-line type gaming session, in which case the gambler is generally registered and therefore his/her behaviour during the previous sessions is known.

The warning message is preferably selected from a message library with variable content according to the value corresponding to the predisposition of the gambler to develop ludopatia. The messages are then prepared with content containing increasingly alarming warnings as the behaviour of the gambler progressively degenerates.

In addition to the content of the message, for example also the time each message remains on the interface monitor between the game and the gambler can be varied according to the value corresponding to the predisposition of the gambler to develop ludopatia.

At least one of the messages can also be advantageously used to inform gamblers that, if they continue with their potentially dangerous behaviour, at least some of the payback and/or probabilistic distribution of the prizes parameters will be modified.

Alternatively, one or more of the characteristic parameters of the game can be modified so that it is imperceptible to the user. However, considering that here we are interested in preventing the onset of ludopatia in the gambler rather than remedying an addiction that has already developed, a message that informs the user of the imminent modification of the game parameters can be particularly effective and, contrarily to other warning messages already displayed previously, it will be difficult for the gambler to ignore it.

The data relative to the behaviour of the gambler during a gaming session are preferably sent to a central computer for collection and statistical analysis of the data in a pre-set time interval. The data can be used for example to monitor the diffusion and gravity of the gambling addiction. An advantageous use of the data thus collected furthermore allows updating of the behavioural reference model.

In practice, the behavioural reference model and/or the threshold pre-set in the range of the scale of values corresponding to the psychometric measurement of various degrees of ludopatia can vary according to the territory in which the gaming session takes place. This allows evaluation of the risk of developing ludopatia also taking account of social and environmental factors that can differ in different areas of the territory.

According to another aspect of the present invention, a system is provided for controlling the course of a game and preventing the development of ludopatia in a gambler who interacts with an on-line type terminal or with a video lottery type terminal, said system comprising:
a plurality of terminals, each having an interface that allows the gambler to interact with the game;
a central computer containing at least one behavioural reference model constructed on the basis of statistics relative at least to the sums bet, the sums lost and the sums won in the context of a significant sample of gamblers, in which the behavioural reference model provides a scale of values corresponding to the psychometric measurement of various degrees of ludopatia;
transmission and reception means for remote connection of the terminals to the central computer;
means for identifying the behaviour of the gambler during at least one gaming session and assigning a value corresponding to the predisposition of the gambler to develop ludopatia on the basis of the gambler's behaviour;
each of the terminals comprising at least one interface monitor between game and gambler to display at least one warning message if the value corresponding to the predisposition of the gambler to develop ludopatia exceeds a pre-defined threshold in the range of the scale of values corresponding to the psychometric measurement of various degrees of ludopatia.

In a system according to the present invention, if the gambler who interacts with the game via a terminal manifests a potentially pathological behaviour, the central computer comprises means for ordering the modification of at least one of the payback and probabilistic distribution of the prizes parameters of the game in progress on that particular terminal.

In short, the method according to the invention also has the advantage of providing a very useful tool for the central administrations, for example for identifying any illegal behaviour by the concessionaires, and this is useful also for the concessionaires themselves: in fact, according to the current laws, the promotion of responsible gaming behaviour and supervision of its adoption by the gamblers is one of the obligations of the concessionaire, and is one of the conditions for access to the concession.

### BRIEF DESCRIPTION OF THE DRAWINGS

Further characteristics and advantages of the present invention will become clearer from the following description, provided for illustrative non-limiting purposes with reference to the accompanying drawings, in which:

FIG. 1 is a diagram of a possible form of implementation of the method according to the present invention.

### METHOD FOR CARRYING OUT THE INVENTION

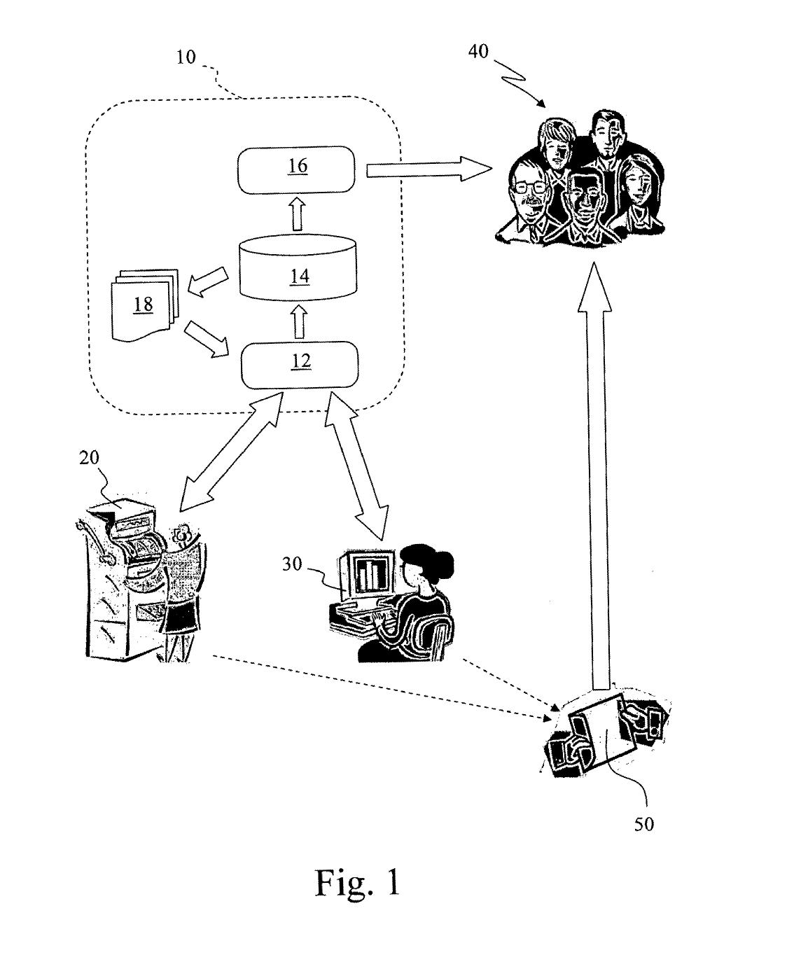

FIG. 1 shows a set of hardware and software resources, identified below as central computer 10, which interact for example with terminals 20 for video lottery type games (e.g. slot-machines, video-poker or similar) and/or with terminals 30 for on-line type games (e.g. on-line poker and bingo or similar) which allow acquisition of the bets and disbursement of any wins.

The terminals 20 and 30 interact with a control program 12 which comprises instructions for identifying the behaviour of each gambler during a gaming session at the respective terminals 20 and 30 and displaying the warning messages on the monitor of the terminals. The exchange of data and messages between the terminals 20 and 30 and the program 12 can be performed via standard protocols dedicated to these types of applications or in any case via IT mechanisms suitable for allowing real-time analysis of the gambler and display of the messages for the prevention of ludopatia.

For example, in the case of the terminals 20 for video lottery type games, the XML standard protocol identified by the initials “G2S” (Game to System standard) produced by GSA (Gaming Standards Association) is already adopted with the control and accounting systems as part of a policy of standardisation to be extended to all gambling sectors. The G2S protocol permits detailed information to be received in real time on the gaming activities and allows communication with the gambler.

The history of the gaming behaviour, of the assessments and the messages issued is filed in a memory unit 14 and made available to an analysis program 16. The operating parameters of the control program 12, and in particular its orientation towards the various types of game, are the result of a set 18 of behavioural models (or learning models).

The analysis program 16 provides data and statistics to an observatory 40 comprising experts in various disciplines. These are responsible for performing assessments of the risk of developing ludopatia at various levels of statistical aggregation (type of game, geographical region, etc. . . . ) and for verifying the effectiveness of the program 12 with which the gamblers interact. In practice, the program 16 is the statistical analysis tool made available to the observatory 40 to monitor the gaming activities, the ludopatia risk assessments and, in particular, the prevention effectiveness of the messages provided by the control program 12.

The analysis program 16 also allows entry of the results of the ludopatia assessments measured directly by the observatory 40 via the administration of questionnaires 50, for example questionnaires of type SOGS (South Oaks Gambling Screen—Lesieur H. R., Blume S. B., 1987, Am. J. Psychiatry, 144:9) which are used to define and update the behavioural models 18.

The method according to the invention, implemented by the control program 12, functions in the same way as a questionnaire of this type, but without asking the gambler questions: in practice, the gaming situations of the gambler are used as questions and the gambler's answers will be determined by whether he/she continues to gamble or not. However, this does not rule out the use of real questionnaires in combination with the findings of the control program.

For example, in the case of the terminals 20 for the video lottery type games in which the gambler is not identified, the identification code of the terminal and the time of beginning and end of use of the terminal by a gambler are noted. This information allows the gaming data coming from the terminals 20 of a given concessionaire to be cross-referenced with the results of the behavioural models defined via the SOGS questionnaires or similar.

In the case of on-line games via terminals 30, for which the gambler is registered beforehand, SOGS questionnaires can also be provided via web which, associated with the gambler's identification code, can be cross-referenced with the on-line gaming data made available by the national administrations.

During operation, assuming for example an interaction with terminals 20 for video lottery type games, the protocol G2S allows connection with the terminal, or the network of terminals, which constitutes the gaming context and obtaining of detailed information in real time on the activities of the gamblers without the need to identify them personally.

If information is received from one or more terminals 20 concerning signs of detachment of the gambler from the real world during the same gaming session, indicated for example by practically automatic impulses and increasingly rapid, i.e. reckless reactions, the control program 12 continues to remain connected to the entire gaming field, however vast it may be, and automatically sends one or more alert messages, calibrated according to the gravity or persistence of the detachment, to the gamblers who manifest this behaviour.

In the case of on-line games via the terminals 30, for which the identity of the gambler is generally known, the gaming behaviour of the gambler can take account of the gaming behaviour identified during a certain number of previous sessions, or in any case sessions held during a given time interval.

If, after receiving various increasingly incisive messages, the gambler perseveres in his/her behaviour tending potentially to the development of ludopatia, the central computer 10 is programmed to modify the parameters payback and/or statistical distribution of the game prizes, so as to induce the gambler to modify his/her behaviour.

In the case of video lottery type games, the parameters are modified during the same gaming session, while in the case of on-line type games, generally characterised by less frequent gaming sessions, the parameters are modified before the beginning of a new gaming session.

In any case, the parameters can be modified in a way that is totally imperceptible to the user. Nevertheless, in order to increase the effectiveness of prevention of the method, it is preferable for the user to be warned by at least one message concerning the imminent modification of the characteristic parameters of the game, so that the gambler realises in more concrete terms that his/her previous behaviour constitutes a risk of developing a pathological condition.

Various modifications can be made to the embodiments represented here without departing from the scope of the present invention. For example, the method can be applied also to several types of game (bingo, bets, lotteries, etc.) just as the interaction between the gamblers and the various types of game can be achieved via portable devices, for example palm-top computers, smartphone type devices, tablet type devices and similar.

1. A method for preventing the development of ludopatia in a gambler who interacts with an on-line or video lottery type game during one or more gaming sessions, the characteristics of said game being defined at least by the parameters of payback and probabilistic distribution of the prizes, comprising the steps of:
a) providing a behavioural reference model constructed on the basis of statistics relative at least to the sums bet, the sums lost and the sums won in the context of a significant sample of gamblers, in Which said behavioural reference model provides a scale of values corresponding to the psychometric measurement of various degrees of ludopatia;
b) identifying the behaviour of the gambler during at least one gaming session and associating a value corresponding to the predisposition of the gambler to develop ludopatia on the basis of the behaviour of said gambler; and
c) displaying at least one warning message on an interface monitor between game and gambler if the value corresponding to the predisposition of the gambler to develop ludopatia exceeds a threshold pre-defined in the range of the scale of values corresponding to the psychometric measurement of various degrees of ludopatia, wherein at least one of said parameters of payback and probabilistic distribution of the prizes are modified to induce the gambler to modify his/her behaviour.

2. The method as claimed in claim 1, wherein the behaviour of the gambler is determined at least on the basis of the sums bet, the sums won, the sums lost, the duration of each. gaming session, the time elapsing between two successive gaming sessions, or the time elapsing between two successive bets within the same gaming session, and the number of messages already displayed in the current gaming session and/or in the previous gaming sessions.

3. The method as claimed in claim 1, wherein said at least one warning message is selected from a library of messages with content varying according to the value corresponding to the predisposition of the gambler to develop ludopatia.

4. The method as claimed in claim 1, wherein the time said at least one message remains on the interface monitor between game and gambler depends on the value corresponding to the +predisposition of the gambler to develop ludopatia.

5. The method as claimed in claim 1, wherein at least one of said messages informs the gambler before modifying at least one of said parameters of payback and probabilistic distribution of the prizes.

6. The method as claimed in claim 1, wherein the data relative to the behaviour of the gambler during a gaming session are transmitted to a central computer for collection and statistical analysis of the data in a pre-defined time interval.

7. The method as claimed in claim 6, wherein said data collected are used to update said behavioural reference model,

8. The method as claimed in claim 1, wherein said behavioural reference model and/or the threshold pre-defined in the range of the scale of values corresponding to the psychometric measurement of various degrees of ludopatia are variable according to the territory in which the gaming session takes place.

9. A system for controlling the course of a game and preventing the development of ludopatia in a gambler who interacts with an on-line or video lottery type terminal, the characteristics of said game being defined at least by the parameters of payback and probabilistic distribution of the prizes, the system comprising:
a plurality of terminals, each one having an interface that allows interaction of the gambler with the game;
a central computer containing at least one behavioural reference model constructed on the basis of statistics relative to at least the sums bet, the sums lost and the sums won in the context of a significant sample of gamblers, in which said behavioural reference model provides a scale of values corresponding to the psychometric measurement of various degrees of ludopatia;
transmission and reception means for remote connection of said terminals to said central computer;
means for identifying the behaviour of the gambler during at least one gaming session and associating a value corresponding to the predisposition of the gambler to develop ludopatia on the basis of the gambler's behaviour;
each of said terminals comprising at least one interface monitor between game and gambler to display at least one warning message if the value corresponding to the predisposition of the gambler to develop ludopatia exceeds a threshold pre-defined in the range of the scale of values corresponding to the psychometric measurement of various degrees of ludopatia,
wherein said central computer comprises means for ordering the modification. of at least one of said parameters of payback and probabilistic distribution of the prizes of the game in progress on a terminal if the gambler who interacts with said game manifests a potential ludopathy behaviour.
